(19) United States
(12) Patent Application Publication
(10) Pub. No.: US 2016/0328786 A1
(43) Pub. Date: Nov. 10, 2016

(54) E-COMMERCE AND SOCIAL NETWORKING PLATFORM

(71) Applicant: QUANTOMIC LLC, Conroe, TX (US)

(72) Inventor: Karim Hijazi, Conroe, TX (US)

(21) Appl. No.: 15/110,394

(22) PCT Filed: Dec. 31, 2014
(86) PCT No.: PCT/US14/72950

§ 371 Date: Jul. 7, 2016

Related U.S. Application Data
(60) Provisional application No. 61/924,554, filed on Jan. 7, 2014.

(51) Int. Cl. G06Q 30/06; H04L 29/08

(52) U.S. Cl. CPC G06Q 30/0643; H04L 67/02; G06Q 50/01

(57) ABSTRACT

Implementations include actions of receiving digital content, the digital content being received from a user, receiving user input, the user input defining a set of tags to be associated with the digital content, the set of tags including one or more tags, each tag providing a channel through which users can procure one or more products and/or services, in response to receiving the user input, associating meta-data with the digital content to provide tagged digital content, the meta-data defining the one or more tags of the set of tags, distributing the tagged digital content for display of the digital content and the set of tags to one or more users, determining that a compensation event has occurred based on the tagged digital content, and facilitating compensation of the user based on the compensation event.

### BACKGROUND

Computer-implemented services, such as content-sharing services enable users to share digital content with one another. Example digital content includes digital images and video.

### SUMMARY

This specification relates to a platform that merges electronic commerce (“e-commerce”) services and social networking services.

Implementations of the present disclosure are generally directed to a social networking and e-commerce platform that enables users to share digital content and receive compensation based on the digital content. More particularly, implementations of the present disclosure provide an integrated social and e-commerce platform that enables users to share digital content and receive compensation based on items depicted in digital content that is shared with other users.

In general, innovative aspects of the subject matter described in this specification can be embodied in methods that include actions of receiving digital content, the digital content being received from a user, receiving user input, the user input defining a set of tags to be associated with the digital content, the set of tags including one or more tags, each tag providing a channel through which users can procure one or more products and/or services, in response to receiving the user input, associating meta-data with the digital content to provide tagged digital content, the meta-data defining the one or more tags of the set of tags, distributing the tagged digital content for display of the digital content and the set of tags to one or more users, determining that a compensation event has occurred based on the tagged digital content, and facilitating compensation of the user based on the compensation event. Other implementations of this aspect include corresponding systems, apparatus, and computer programs, configured to perform the actions of the methods, encoded on computer storage devices.

These and other implementations can each optionally include one or more of the following features: at least one tag of the set of tags includes a user-defined tag, at least one tag of the set of tags includes an affiliate tag, the affiliate tag is selected by the user from a library of affiliate tags, at least one tag of the set of tags includes an enterprise tag, at least one tag of the set of tags includes a link to a resource, through which users are able to procure the one or more products and/or services, the resource includes a web-site, the compensation event includes a conversion, the conversion is initiated through a tag of the set of tags, the compensation event includes an impression, the impression including a view of the tagged digital content, the compensation event includes a click-on at least one of the tagged digital content and a tag of the set of tags.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts an example environment in which users can interact with one or more computer-implemented services.

FIG. 2 depicts an example environment in accordance with implementations of the present disclosure.

FIG. 3 depicts an example process that can be executed in accordance with implementations of the present disclosure.

FIG. 4 depicts an example process that can be executed in accordance with implementations of the present disclosure.

FIGS. 5-8 depict example screenshots that can be provided in accordance with implementations of the present disclosure.

Like reference numbers and designations in the various drawings indicate like elements.

### DETAILED DESCRIPTION

Implementations of the present disclosure are generally directed to a social networking and e-commerce platform that enables users to share digital content and be compensated based on the digital content. More particularly, implementations of the present disclosure provide an integrated social networking and e-commerce platform (hereinafter referred to as the “integrated platform”) that enables users to share digital content and receive compensation based on items depicted in digital content that is shared with other users. Example digital content can include images and video. In some examples, a user can upload digital content to the integrated platform. In some examples, the user can tag one or more items depicted in the digital content. In some examples, a tag includes associated meta-data that relates the tag to the respective item. In some examples, each tag is associated with one or more commerce channels. In some examples, a commerce channel includes a channel, through which a product and/or service can be purchased. In some examples, the product and/or service can be represented by a respective item that is depicted in the digital content.

In some implementations, and as discussed in further detail herein, a user can upload an image to the integrated platform, and the image can be displayed to the user. In some examples, the user can select (e.g., click-on) an item depicted in the image and can associate a tag with the item. The user can tag one or more items depicted in the image. In some examples, the user can generally associate one or more tags with the image itself (e.g., as opposed to distinct items depicted in the image). In some examples, the image can be processed to automatically determine one or more items depicted in the image. For example, a recognition engine (e.g., provided as one or more computer-executable programs) can process the image to recognize items depicted in the image, which items can be mapped to pre-defined, known items. In some examples, one or more tags can be recommended to the user based on items provided in the image. In some examples, the user can select a tag from the one or more recommended tags, and can associate the tag with a respective item depicted in the image.

In some implementations, users receive compensation for products and/or services that are purchased. In some examples, a purchase of a product and/or service can be referred to as a conversion. In accordance with implementations of the present disclosure, users can be compensated for conversions that result from digital content that the users have shared. In some examples, compensation can include monetary compensation. For example, in response to a conversion resulting from digital content shared by a user, the user can receive a monetary fee. In some examples, an account associated with the user can be credited in the amount of the fee. In some examples, users can receive non-monetary compensation. For example, in response to a conversion resulting from digital content shared by the user, the user can receive a credit and/or discount (e.g., coupon) that can be used to purchase goods and/or services.

In some implementations, a plurality of tag types can be provided. Example tag types can include user-defined tags and affiliate tags. In some examples, user-defined tags can include tags that are provided based on user input to the platform. In some examples, user-defined tags identify products and/or services that a respective user offers (e.g., for sale). In some examples, user-defined tags identify products and/or services that a respective retailer and/or service provider offers (e.g., for sale). In some implementations, a user interface can be provided that enables a user to input details associated with the tag. Example details can include one or more images (e.g., in addition to the image that is to be tagged), a description, product specifications, terms of service, price, shipping options, one or more resource links (e.g., hyperlinks to respective Internet-based resources), and the like.

In some examples, a selling user can upload an image that depicts products and/or services that the selling user is offering. The selling user can tag the image with one or more user-defined tags that are specific to the products and/or services being offered. In some examples, a buying user can initiate purchase of the products and/or services from the selling user (e.g., by selecting a tag within the image). In some examples, the operator of the integrated platform is compensated in response to the sale. In some examples, the selling user provides a percentage of the sale to the operator of the integrated platform. In some examples, the selling user provides a fee (e.g., fixed fee) to the operator of the integrated platform.

For example, a user “Grandmother” can upload a picture of an array of baskets that are for sale. The user “Grandmother” can define one or more user-defined tags that can be associated with the image to enable other users (e.g., buying users) to purchase respective baskets depicted in the image from the user “Grandmother.” In some examples, the operator of the integrated platform receives compensation for one or more sales of baskets.

In some examples, a plurality of affiliate tags can be provided by the integrated platform. In some examples, the integrated platform can provide a library of affiliate tags (e.g., stored in a database). In some examples, each tag is associated with a respective product and/or service, as well as a respective provider of the product and/or service. For example, a retail user can interact with the integrated platform to create an affiliate tag that can be stored to the library of affiliate tags. In some implementations, a user interface can be provided that enables the retail user to input details associated with the affiliate tag. Example details can include one or more images (e.g., in addition to the image that is to be tagged), a description, product specification, terms of service, price, shipping options, one or more resource links (e.g., hyperlinks to respective Internet-based resources), and the like.

In some examples, a user can upload an image that depicts items (e.g., products and/or services). The user can tag the image with one or more affiliate tags that are associated with retailers, from which the items can be purchased. In some examples, a buying user can initiate purchase of the products and/or services from respective retailers through the image (e.g., by selecting an affiliate tag within the image). In some examples, the operator of the integrated platform is compensated in response to the sale. In some examples, the retailer provides a percentage of the sale to the operator of the integrated platform. In some examples, the retailer provides a fee (e.g., fixed fee) to the operator of the integrated platform. In some examples, the user that uploaded and tagged the image can be compensated. In some examples, the user is compensated by the operator of the integrated platform. In some examples, the user is compensated by the retailer.

For example, a user can upload an image of a sport-utility vehicle that includes after-market components (e.g., tires, bumpers, headlights). The user can search the library of affiliate tags for the retailer, from which the user had purchased the after-market components, and can tag the image with one or more affiliate tags. In this manner, other users that view the image can be informed as to details of respective components and retail providers of the respective components, and can initiate purchases of respective components. In some examples, the user that uploaded the image and/or the operator of the integrated platform can be compensated for each sale.

In some implementations, tags can include text tags, video tags, streaming tags, audio tags, serial post tags, and spin-off post tags. In some examples, a text tag can provide textual information that can provide additional context for an item within an image. In some examples, a text tag can include a textbox description (e.g., displaying HTML text) and/or one or more additional images. For example, an image can depict an athlete in mid-air, performing a backflip on a bicycle. A text tag can be associated with the image. A user viewing the image can interact with the text tag (e.g., click-on, hover over), and in response, text can be displayed noting that the ending of the stunt was not so elegant, and an image can be displayed showing the athlete in a cast.

In some examples, a video tag can provide an embedded video and/or a link to a video that can provide additional context for an item within an image. For example, an image can depict a sports car. A video tag can be associated with the image. A user viewing the image can interact with the video tag (e.g., click-on, hover over), and in response, a video can be displayed that depicts the sports car racing around a track.

In some examples, a streaming tag can provide streaming video associated with subject matter of an image, which streaming video that can provide additional context for an item within an image. For example, an image can depict Paris. A streaming tag can be associated with the image, the streaming tag playing video provided from a web-cam in Paris (e.g., streaming video from a web-cam mounted on the Eiffel Tower). A user viewing the image can interact with the streaming tag (e.g., click-on, hover over), and in response, the streaming video can be displayed.

In some examples, an audio tag can provide audio associated with subject matter of an image, which audio that can provide additional context for an item within an image. For example, an image can depict a hand-crafted vase. An audio tag can be associated with the image, the audio tag playing audio provided from the artist that created the vase (e.g., explaining the medium and technique used to create the vase). A user viewing the image can interact with the audio tag (e.g., click-on, hover over), and in response, the audio can be played.

In some examples, a serial post tag can link images and/or social networking posts to provide additional context. More particularly, a series of serial post tags can be used to tell a story and/or convey some kind of information to users. For example, an image can depict an athlete in mid-air, performing a stunt on a bicycle. A serial post tag can be associated with the image. A user viewing the image can interact with the serial post tag (e.g., click-on, hover over), and in response, an image depicting people building the ramp, from which the athlete jumped to perform the stunt can be displayed.

In some examples, a spin-off post tag can be associated with a particular item depicted in an image to link images and/or social networking posts and provide additional context. For example, an image can depict an athlete in mid-air, performing a stunt on a bicycle. A spin-off post tag can be associated with the image. A user viewing the image can interact with the spin-off post tag (e.g., click-on, hover over), and in response, an image depicting a different athlete in mid-air on a skateboard can be displayed.

In accordance with implementations of the present disclosure, the integrated platform provides a social networking service, through which users can upload digital content, tag digital content, and distribute digital content to other users. For example, users can register with the integrated platform and can create user credentials that can be used to authenticate the users to the integrated platform. In some examples, each user can define a user profile that can include detail that is relevant to the respective user. Example detail can include name, location, biography, hobbies, education, education, skills, and the like. In some examples, detail can include account information. Example account information can be associated with an account that the user can use to make purchases, and/or that the user can use to receive compensation (e.g., bank account information, credit card information).

In some examples, and as discussed in further detail herein, the integrated platform can provide one or more interfaces that enable users to view digital content that has been distributed through the social networking service, to upload digital content, to tag digital content, and/or to distribute digital content. In some examples, interfaces can be provided using one or more web pages that can be displayed using a web browser application executed on a computing device (e.g., a desktop computer, a laptop computer, a tablet computing device, a smartphone). In some examples, interfaces can be provided by a dedicated application, such as a mobile application (“mobile app”), that can be executed on a computing device (e.g., a smartphone, a tablet computing device).

In some implementations, users can export tagged digital content to one or more third-party distribution channels. Example third-party distribution channels can include one or more computer-implemented services, such as, for example, a third-party social networking service, a micro-blogging service, a blogging service, an image-sharing service, and the like. Accordingly, users can distribute tagged digital content using the social networking service of the integrated platform, and/or third-party services. In this manner, tagged digital content can reach a broader audience than that of the social networking service of the integrated platform alone, such that conversions can be initiated through third-party services and/or the integrated platform.

In some examples, the user that provided the image can be compensated in response to occurrence of a compensation event. Example compensation events can include a click event (e.g., another user clicking on the image and/or tag within the image), an impression event (e.g., another user viewing the image), and a conversion event (e.g., a conversion that had been initiated through the image). In some examples, click events enable users to be compensated on a per-click basis (e.g., each time another user clicks on the image and/or tag within the image, the user that provided the image is compensated). In some examples, impression events enable users to be compensated on a per-impression basis (e.g., each time another user views the image, the user that provided the image is compensated). In some examples, conversion events enable users to be compensated based on conversions (e.g., each time a conversion results from the image, the user is compensated). In some examples, the operator of the integrated platform can be compensated. In some examples, click events enable the operator to be compensated on a per-click basis (e.g., each time another user clicks on the image and/or tag within the image, the operator is compensated). In some examples, impression events enable the operator to be compensated on a per-impression basis (e.g., each time a user views the image, the operator is compensated). In some examples, conversion events enable the operator to be compensated based on conversions (e.g., each time a conversion results from the image, the operator is compensated).

In some implementations, the integrated platform determines unique compensation events to inhibit redundant compensation, and/or inhibit compensation. In some examples, the user that provided the image and/or the operator are only compensated for unique compensation events. For example, the integrated platform can determine and/or be informed of the user that has viewed an image, clicked on the image and/or tag within the image, and/or has completed a conversion initiated through the image. In some examples, the integrated platform can compare the user that interacted with the image to other users that had previously interacted with the image (e.g., clicked on, viewed, completed a conversion through). In some examples, if it is determined that the user has previously interacted with the image (e.g., the user is included in a list of users that had previously interacted with the image), the user and/or the operator are not compensated for the current interaction. In some examples, if it is determined that the user has not previously interacted with the image (e.g., the user is not included in a list of users that had previously interacted with the image), the user and/or the operator are compensated for the current interaction (e.g., the current interaction is deemed to be a compensation event).

In some implementations, the integrated platform enables enterprises to promote products, services and/or brands. An example enterprise can include a commercial entity (e.g., a retail company) that offers products and/or services. In some implementations, enterprises can provide enterprise tags that can be used to tag user-provided images. In some examples, enterprise tags include tags, for which enterprises compensate users and/or the operator of the integrated platform to have the users include the tag within an image. In some examples, enterprise tags can be referred to as sponsored tags. In some examples, enterprise tags can include tags that are associated with particular items depicted within the image. In some examples, enterprise tags can include tags that are not associated with particular items depicted within the image, but instead are associated with the overall image (e.g., sponsoring the image itself, as opposed to individual objects depicted in the image). In some examples, enterprises can offer respective enterprise tags associated with an image. That is, an image can be tagged with a plurality of enterprise tags, where at least one enterprise tag is associated with an enterprise that is different from an enterprise associated with at least one other enterprise tag.

For example, a user can upload an image depicting Paris, which image becomes popular with other users (e.g., the image is often viewed by other users of the integrated platform). In view of the popularity of the image, the Parisian Tourism Board can provide an enterprise tag that the user can associate with the image. In this example, the enterprise tag can be a sponsored link that users can select (e.g., click-on) to be presented with additional information regarding Paris (e.g., travel to Paris, hotels, sight-seeing, tours, and the like). In response to a user clicking on the enterprise tag, the user and/or the operator of the integrated platform can be compensated by the Parisian Tourism Board.

In some examples, the user that provided the image can be compensated by the enterprise(s). For example, and as discussed above with respect to user-defined tags and affiliate tags, the user can be compensated in response to occurrence of a compensation event. In some examples, click events enable users to be compensated on a per-click basis (e.g., each time another user clicks on the image and/or tag within the image, the user that provided the image is compensated by the enterprise). In some examples, impression events enable users to be compensated on a per-impression basis (e.g., each time another user views the image, the user that provided the image is compensated by the enterprise).

In some examples, conversion events enable users to be compensated based on conversions (e.g., each time a conversion results from the image, the user is compensated by the enterprise). In some examples, the operator of the integrated platform can be compensated by the enterprise(s). In some examples, click events enable the operator to be compensated on a per-click basis (e.g., each time another user clicks on the image and/or tag within the image, the operator is compensated by the enterprise). In some examples, impression events enable the operator to be compensated on a per-impression basis (e.g., each time a user views the image, the operator is compensated by the enterprise). In some examples, conversion events enable the operator to be compensated based on conversions (e.g., each time a conversion results from the image, the operator is compensated by the enterprise).

In some implementations, and as discussed above with respect to user-defined tags and affiliate tags, the integrated platform determines unique compensation events to inhibit redundant compensation, and/or inhibit compensation based on enterprise tags. In some examples, the user that provided the image and/or the operator are only compensated for unique compensation events. For example, the integrated platform can determine and/or be informed of the user that has viewed an image, clicked on the image and/or tag within the image, and/or has completed a conversion initiated through the image. In some examples, the integrated platform can compare the user that interacted with the image to other users that had previously interacted with the image (e.g., clicked on, viewed, completed a conversion through). In some examples, if it is determined that the user has previously interacted with the image (e.g., the user is included in a list of users that had previously interacted with the image), the user and/or the operator are not compensated for the current interaction. In some examples, if it is determined that the user has not previously interacted with the image (e.g., the user is not included in a list of users that had previously interacted with the image), the user and/or the operator are compensated for the current interaction (e.g., the current interaction is deemed to be a compensation event).

In some implementations, enterprises can bid to have respective enterprise tags associated with digital content. In some examples, bidding is based on a popularity of the digital content. For example, the more popular an item of digital content is, the more expensive it can be to an enterprise to have their enterprise tag(s) associated with the image. In this manner, enterprises can use digital content as a means of advertising products, services and/or brands.

In some examples, the user that provided the digital content is compensated in response to an enterprise tag being associated with the digital content. For example, an enterprise with the highest bid can have one or more enterprise tags associated with the digital content, and the user is compensated in response to the one or more enterprise tags being associated with the digital content. In some examples, the user is solely compensated based on inclusion of the enterprise tag with the digital content. In some examples, the user is compensated based on inclusion of the enterprise tag with the digital content, and/or compensation events, discussed in further detail herein.

In some examples, one or more costs can be associated with an enterprise tag. Example costs can include a per-click cost, a per-impression cost, and/or a conversion cost. In some examples, a per-click cost reflects compensation paid by the enterprise to the user (that uploaded the respective image) and/or the operator of the integrated platform in response to a user interacting with (e.g., clicking-on) the enterprise tag. In some examples, a per-impression cost reflects compensation paid by the enterprise to the user (that uploaded the respective image) and/or the operator of the integrated platform in response to a user viewing the digital content, within which the enterprise tag is provided. In some examples, a conversion cost reflects compensation paid by the enterprise to the user (that uploaded the respective image) and/or the operator of the integrated platform in response to a conversion that was initiated through the enterprise tag.

In some examples, a minimum cost can be provided based on the popularity of the image. In some examples, the cost can increase from the minimum cost based on bidding between enterprises, where the enterprise offering the highest bid is able to have a respective enterprise tag associated with the image. In some examples, if multiple enterprises are not bidding, a single enterprise can provide a respective enterprise tag for the minimum cost.

In some examples, each item of digital content (e.g., image) can be associated with a respective popularity score. In some examples, a popularity scoring service can process the image and/or parameters associated with the image to determine the popularity score for the image. Example parameters can include a number of impressions (e.g., a number of times users have viewed the image), a number of times that the image has been shared by other users, a number of times the image has been surfaced in search results, a number of unique tags associated with the image, a number of times that the image has been embedded in third-party services (e.g., third-party web sites), a number of embedded impressions (e.g., a number of times users have viewed the image in third-party services), a number of conversions that were initiated from the image, a number of comments associated with the image, a rate of rise associated with the image, and locations (geo-locations) of users that have viewed the image. In some examples, parameters that are used to determine the popularity score can be weighted. In this manner, less relevant parameters have less influence on the popularity score than do more relevant parameters.

In some implementations, digital content can be associated with one or more categories of products and/or services. For example, an image can depict a pair of sunglasses, a handbag, and a car, reflecting categories of eyewear, accessories, and automobiles, respectively. In some implementations, digital content can be processed to automatically determine one or more items depicted in the digital, and associated one or more categories. For example, a recognition engine (e.g., provided as one or more computer-executable programs) can process the digital content to recognize items depicted in the content, which items can be mapped to pre-defined categories. In some examples, one or more categories to be associated with the digital content can be manually curated (e.g., defined by the user that uploaded to image).

In some examples, bidding for inclusion of enterprise tags can be provided on a per-category basis. Continuing with the example above, a first eyewear retailer, a second eyewear retailer, and a handbag retailer can enter bids to have respective enterprise tags associated with the image. In some examples, because only a single handbag retailer is involved, the handbag retailer can procure an enterprise tag without competition (e.g., at the minimum cost). In some examples, because multiple eyewear retailers are involved, one of the first eyewear retailer and the second eyewear retailer can procure an enterprise tag, but at an increased cost (e.g., above the minimum cost).

In some implementations, users can be directly compensated. For example, and in response to occurrence of a compensation event an entity (e.g., an enterprise associated with an enterprise tag, a retailer associated with an affiliate tag) can provide compensation directly to the user. In some examples, the integrated platform can facilitate direct compensation. For example, the integrated platform can receive the compensation and can credit the user's account with the compensation. In some implementations, users can be indirectly compensated. For example, and in response to occurrence of a compensation event an entity (e.g., an enterprise associated with an enterprise tag, a retailer associated with an affiliate tag) can provide compensation to the operator and the operator can provide compensation to the user. In some examples, the integrated platform can facilitate indirect compensation. For example, the integrated platform can receive compensation, and can compensate the user. In some examples, compensation provided to the user is based on the compensation received by the integrated platform (e.g., is a percentage of the compensation received by the integrated platform). In some examples, compensation provided to the user is fixed (e.g., is a fee paid by the integrated platform to the user).

In some implementations, the integrated platform provides one or more metrics to enterprises, which metric can be used to evaluate the efficiency and/or performance of associated enterprise tags. In some examples, each enterprise can be provided access to a dashboard, which displays metrics associated with enterprise tags of the respective enterprise. In some examples, the metrics provide data regarding clicks, impressions and/or conversions resulting from digital content that include(s) the enterprise tags. In this manner, enterprises can identify effective and/or ineffective enterprise tags/digital content.

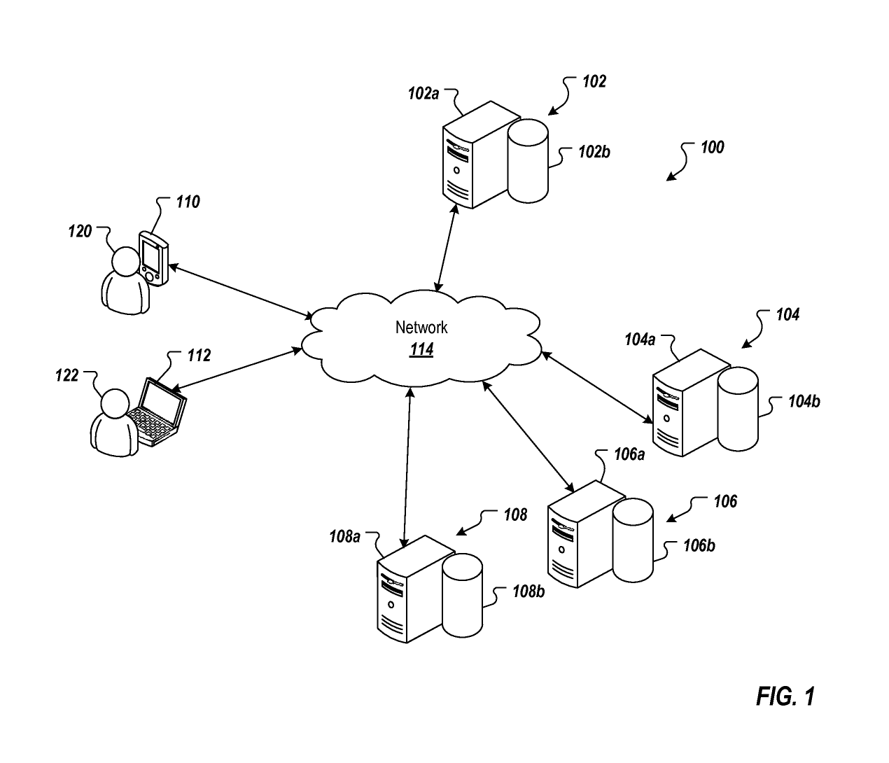

FIG. 1 depicts an example environment 100, in which implementations of the present disclosure can be provided. In some examples, the environment 100 enables users to interact with an integrated platform, as discussed herein. In some examples, the integrated platform enables users to upload digital content, and share digital content with other users of the integrated platform. Example digital content can include images, videos, and text. Implementations of the present disclosure are directed to enabling users to tag digital content, the tags being actionable by other users to procure products and/or services.

With continued reference to FIG. 1, the example environment 100 includes a computing system 102, a computing system 104, a computing system 106, a computing system 108, a computing device 110, a computing device 112, and a network 114. In some examples, the computing systems 102, 104, 106, 108 include respective computing devices 102a, 104a, 106a, 108a and computer-readable memory provided as a persistent storage device 102b, 104b, 106b, 108b. In some examples, the computing systems 102, 104, 106, 108 can represent various forms of server systems including, but not limited to a web server, an application server, a proxy server, a network server, or a server farm.

The computing devices 110, 112 are associated with respective users 120, 122. In some examples, the computing devices 110, 112 can each include various forms of a processing device including, but not limited to, a desktop computer, a laptop computer, a tablet computer, a wearable computer, a handheld computer, a personal digital assistant (PDA), a cellular telephone, a network appliance, a smart phone, an enhanced general packet radio service (EGPRS) mobile phone, or an appropriate combination of any two or more of these example data processing devices or other data processing devices.

The example environment 100 can support a client-server paradigm. For example, the computing devices 110, 112 can be clients and can communicate with one or more back-end server systems (e.g., the computing systems 102, 104, 106, 108) over the network 114. In some examples, the network 114 can be provided as a large computer network, such as a local area network (LAN), wide area network (WAN), the Internet, a cellular network, or a combination thereof connecting any number of clients and servers. In some examples, the computing systems 102, 104, 106, 108 can communicate with one another over the network 114.

In accordance with implementations of the present disclosure, the computing system 102 can provide the integrated platform. For example, the computing system 102 can execute one or more computer-readable programs to provide functionality (e.g., social networking and e-commerce) of the integrated platform discussed herein. In some examples, the computing system 104 can be operated by a first retailer that offers products and/or services. For example, the computing system 104 can execute one or more computer-readable programs to provide functionality for purchasing products and/or services from the first retailer. The computing system 106 can be operated by a second retailer that offers products and/or services. For example, the computing system 106 can execute one or more computer-readable programs to provide functionality for purchasing products and/or services from the second retailer. In some examples, the computing system 108 can be operated by a third-party service provider. For example, the computing system 108 can execute one or more computer-readable programs to provide one or more computer-implemented services (e.g., a social networking service, a micro-blogging service, a blogging service, a content-sharing service).

In accordance with implementations of the present disclosure, the user 120 can interact with the integrated platform to upload and distribute digital content to other users. For example, the user 120 can use the computing device 110 to upload digital content to the integrated platform provided by the computing system 102. In some examples, the user 120 can create a post that includes digital content, and can distribute the post to other users through the social networking service provided by the integrated platform (e.g., the user 122 can view the post using the computing device 112). In some examples, the user 120 can associate one or more tags with the digital content. For example, the user 120 can tag products and/or services that are depicted in the digital content, and/or can tag the digital content itself to provide tagged digital content. In some examples, the user 122 can view a post that includes the tagged digital content by the user 120. The user 122 can interact with a tag (e.g., click-on) to initiate purchase of a product and/or service provided by a retailer (e.g., the first retailer, the second retailer). In some examples, in response to the user 122 interacting with a tag, the user 122 can be put into communication with the computing system 104 to purchase a product from the first retailer. For example, one or more web pages provided by the computing system 104 can be displayed to the user 122, through which the user 122 can purchase products and/or services from the first retailer.

In some implementations, tagged digital content can be exported for display within one or more third-party services. For example, the user 120 can export the tagged digital content to a computer-implemented service provided by the computing system 108. In some examples, the user 122 can interact with the service provided by the computing system 108, through which the tagged digital content can be displayed to the user 122. In some examples, in response to the user 122 interacting with a tag, the user 122 can be put into communication with the computing system 104 to purchase a product from the first retailer. For example, one or more web pages provided by the computing system 104 can be displayed to the user 122, through which the user 122 can purchase products and/or services from the first retailer.

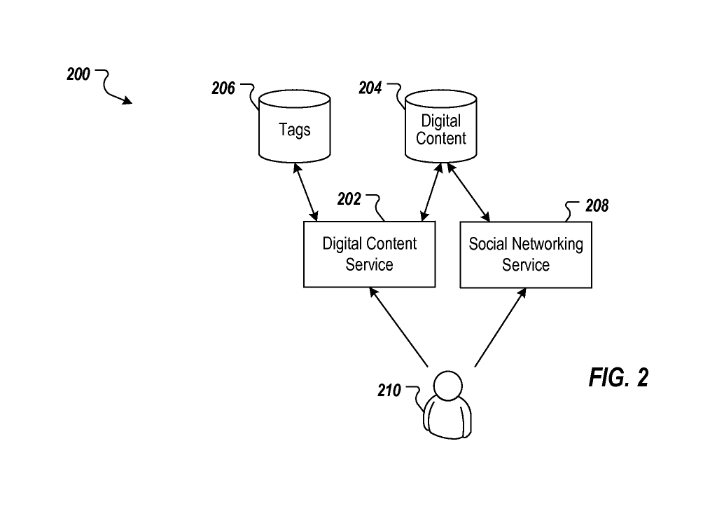

FIG. 2 depicts an example environment 200 in accordance with implementations of the present disclosure. In the depicted example, the environment 200 includes a digital content service 202, a digital content data store 204, a tag data store 206, and a social networking service 208. In some examples, each of the digital content service 202 and the social networking service 208 can be provided as one or more computer-executable programs that can be executed by one or more computing devices (e.g., the computing system 102 of FIG. 1). Although the digital content service 202 and the social networking service 208 are depicted as separate services, in some examples, the digital content service 202 and the social networking service 208 can be provided together as a single service.

In accordance with implementations of the present disclosure, a user 210 can upload digital content (e.g., images, videos) to the digital content service 202, and can interact with the digital content service 202 to tag the digital content with one or more tags. In some examples, the uploaded digital content can be stored in the digital content data store 204. In some examples, pre-stored tags (e.g., user-defined tags, affiliate tags, enterprise tags) can be provided from the tag data store 206. In some examples, the user can interact with the digital content service 202 to provide one or more new user-defined tags, which can be stored in the tag data store 206. The user 210 can tag the digital content with one or more tags to provide tagged digital content that is stored in the digital content data store 204. In some examples, the tagged digital content includes the digital content (e.g., data stored in a file) and meta-data that defines the one or more tags. In some examples, the meta-data includes one or more images, a description, product specification, terms of service, price, shipping options, one or more resource links (e.g., hyperlinks to respective Internet-based resources), tracking information, and the like. In some examples, the tracking information enables the integrated platform and/or a retailer to track the source of a compensation event. In this manner, which user(s) that is/are to be compensated for a compensation event can be determined Example tracking information can include an identifier that is unique to a user that provided the digital content.

In some implementations, the user 210 can interact with the social networking service 208 to distribute the tagged digital content. For example, the user 210 can create a post that includes the tagged digital content and/or additional digital content (e.g., text, geo-location information). The user 210 can distribute the post to other users of the social networking service 208. In some implementations, the user 210 can export the tagged digital content to a third-party service, as discussed herein.

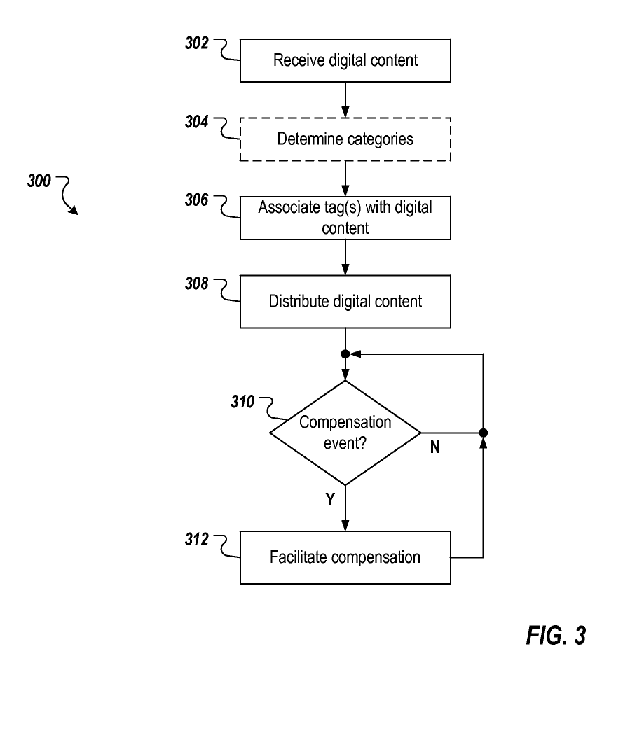

FIG. 3 depicts an example process 300 that can be executed in accordance with implementations of the present disclosure. The example process 300 can be implemented, for example, by the example environment 100 of FIG. 1. In some examples, the example process 300 can be provided by one or more computer-executable programs executed using one or more computing devices.

Digital content is received (302). For example, an integrated platform provided by the computing system 102 of FIG. 1 receives digital content uploaded by the user 120 using the computing device 110. In an optional operation, categories associated with the digital content can be determined (304). For example, the digital content can be processed by the computing system 102 to identify one or more items depicted in the digital content, and to determine respective categories associated with the digital content. One or more tags are associated with the digital content (306). For example, the user 120 can associate one or more tags (e.g., user-defined tags, affiliate tags, enterprise tags) with the digital content using computing device 110 to provide tagged digital content. Tagged digital content is distributed (308). For example, the user 120 uses the computing device 110 to define a post that includes tagged digital content and to distribute the post through the social networking service provide by the integrated platform. In some examples, the tagged digital content is exported for distribution through a third-part service (e.g., provided by the computing system 108). It is determined whether a compensation event has occurred (310). If a compensation event has not occurred, the example process loops back. If a compensation event has occurred, compensation is facilitated (312). For example, the integrated platform facilitates compensation provided to the user 120 in response to occurrence of a compensation event.

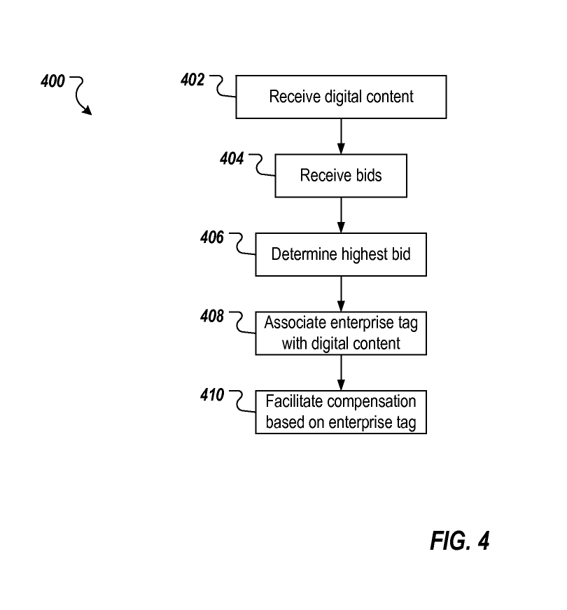

FIG. 4 depicts an example process 400 that can be executed in accordance with implementations of the present disclosure. The example process 400 can be implemented, for example, by the example environment 100 of FIG. 1. In some examples, the example process 400 can be provided by one or more computer-executable programs executed using one or more computing devices.

Digital content is received (402). The digital content is associated with a popularity score and is digital content that was uploaded by a user (e.g., to the computing system 102 of FIG. 1). In some examples, and as discussed in further detail above, the popularity score is based on one or more parameters. Bids are received (404). In some examples, a plurality of bids is received from respective enterprises. In some examples, bids are based on the popularity score. A highest bid of received bids is determined (406). In some examples, the highest bid is associated with an enterprise. An enterprise tag is associated with the digital content to provide tagged digital content (408). The enterprise tag is associated with the enterprise that provided the highest bid. Compensation of the user is facilitated based on the enterprise tag (410). In some examples, compensation is provided to the user in response to inclusion of the enterprise tag in the set of tags. In some examples, it is determined that a compensation event has occurred based on the enterprise tag, and the user is compensated in response to the compensation event.

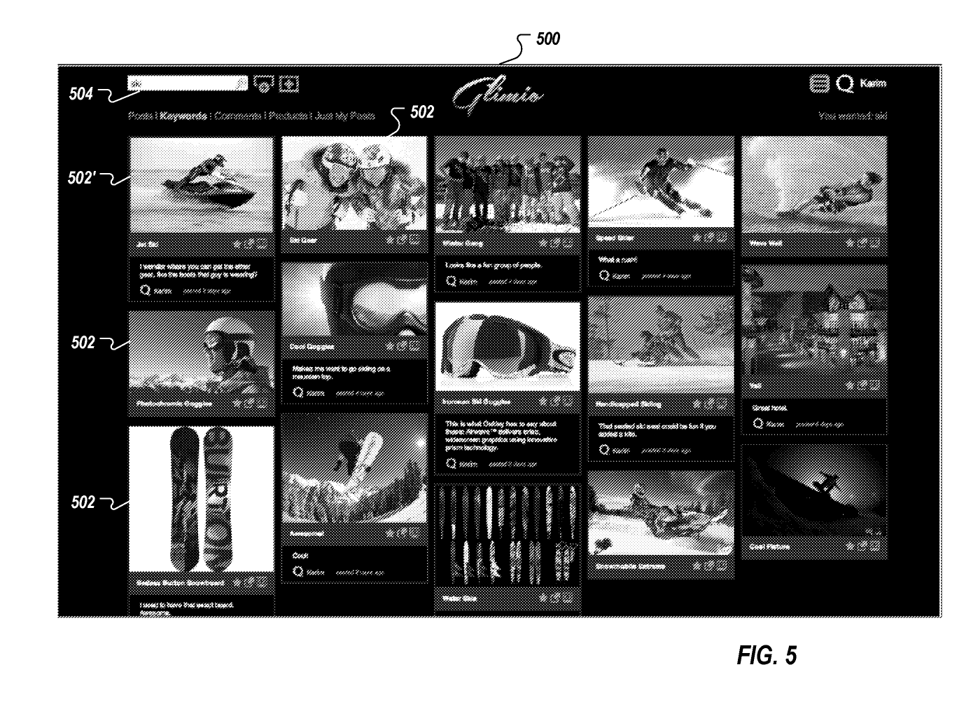

FIGS. 5-8 depict example screenshots that can be provided in accordance with implementations of the present disclosure. In some examples, the screenshots include respective web pages that can be displayed to users through a browser application. In some examples, the screenshots include respective screens that can be displayed by a dedicated application (e.g., a mobile app).

FIG. 5 depicts a screenshot of an example post screen 500 displaying a plurality of posts 502, each of which includes digital content (e.g., images, text). In the depicted example, the posts 502 are displayed based on a keyword that has been input by a user (e.g., Karim). For example, a filter can be applied to select a set of posts that are to be displayed in the post screen 500. Example filters include “Posts,” “Keywords,” “Comments,” “Products,” and “Just My Posts.” In the depicted example, the filter “Keywords” is selected, and the keyword “ski” has been entered into a keyword input element 504. In response to the keyword, a set of posts is provided, which includes posts 502 that are associated with the keyword. In some examples, comments associated with the post can match the keyword(s). In some examples, posts can be explicitly associated with keywords. A user viewing the screen 500 can select a post to view the post in greater detail.

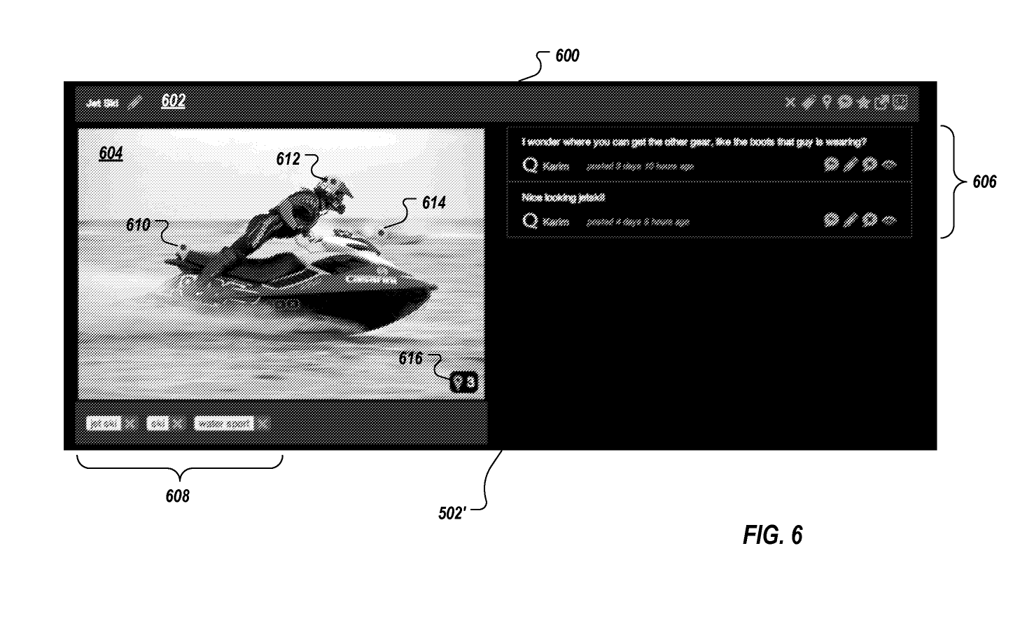

FIG. 6 depicts a partial screenshot including a post interface 600. For example, the post interface 600 can be displayed in response to user selection of a post 502 from the post screen 500. In the depicted example, the post interface 600 is displayed in response to user selection of a post 502′ from the post screen 500 of FIG. 5.

In the depicted example, the post 502′ includes a post title 602 (“Jet Ski”), an image 604, comments 606, keywords 608 (“jet ski,” “ski,” “water sport”). In the depicted example, the image 604 is associated with tags 610, 612, 614, and a tag counter 616 is provided. In some examples, the tag counter 604 indicates the number of tags associated with the image 604. In some examples, the keywords 608 are selected by a user to be associated with the post 502′. In this manner, the post 502′ can be searched for based on keyword, as discussed above with reference to FIG. 5.

In accordance with implementations of the present disclosure, the user viewing the post 502′ can interact with (e.g., click-on, hover-over) one or more of the tags 610, 612, 614. For example, the user can click on the tag 612, and in response, detail regarding the item associated with the tag 612 can be displayed to the user. In some examples, the tags 610, 612, 614 can include user-defined tags, affiliate tags, and/or enterprise tags.

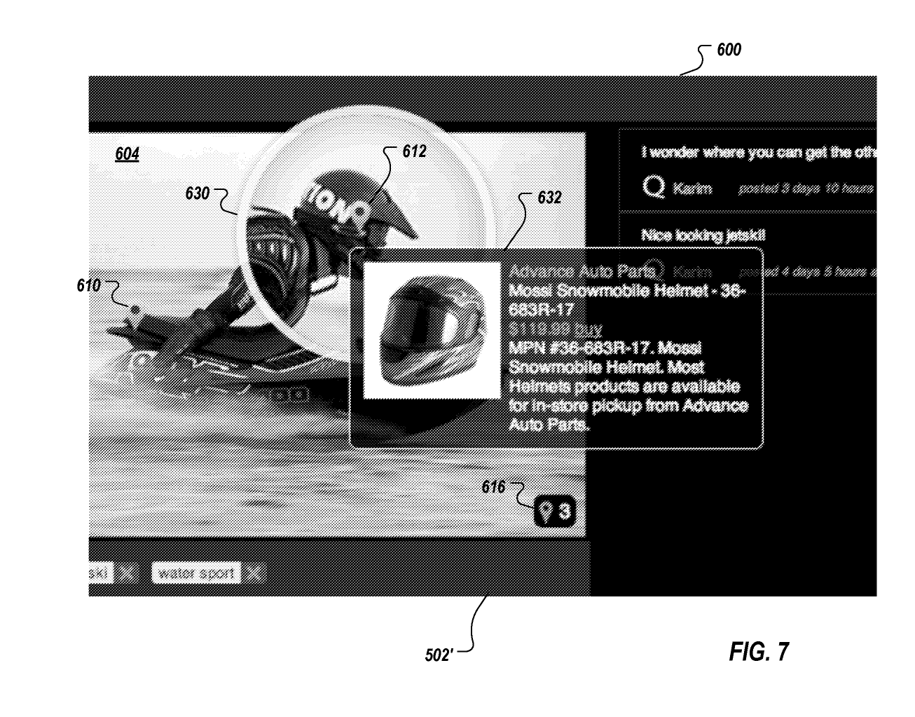

FIG. 7 depicts a portion of the post interface 600 in response to user interaction with the tag 612. In the depicted example, and in response to user interaction with the tag 612, an enlarged portion 630 of the image 604 and a detail interface 632 are displayed. In some examples, the enlarged portion 630 provides further visual detail of the item associated with the selected tag. In the depicted example, the enlarged portion 630 provides visual detail of a helmet associated with the tag 612. The detail interface 632 provides detail regarding the item associated with the selected tag, detail regarding a retailer, from which the item can be purchased, and/or a channel for purchasing the item.

In the depicted example, the detail interface 632 depicts an image of the item, a model of the item (e.g., Mossi Snowmobile Helmet, MPN #36-683R-17), price of the item, and a description of the item. In the depicted example, the detail interface 632 further indicates a retailer that sells the item (e.g., “Advance Auto Parts”), and a channel (e.g., a link “buy”) to initiate purchase of the item. For example, the user can select (e.g., click-on) the channel (“buy”), and in response, the user can navigate to an interface (e.g., a web page) to purchase the item.

In some examples, the tag 612 can be an affiliate tag that is associated with the retailer “Advance Auto Parts.” For example, the retailer can have previously provided tag information (e.g., item image, description, price) to the operator of the integrated platform, which tag information can be stored. A user that uploaded and tagged the image 604 selected the affiliate tag from a library of affiliate tags provided by the integrated platform. In some examples, the tag 612 can be an enterprise tag that is provided by the retailer “Advance Auto Parts.” For example, the retailer can have previously bid to have its tag associated with the image 604.

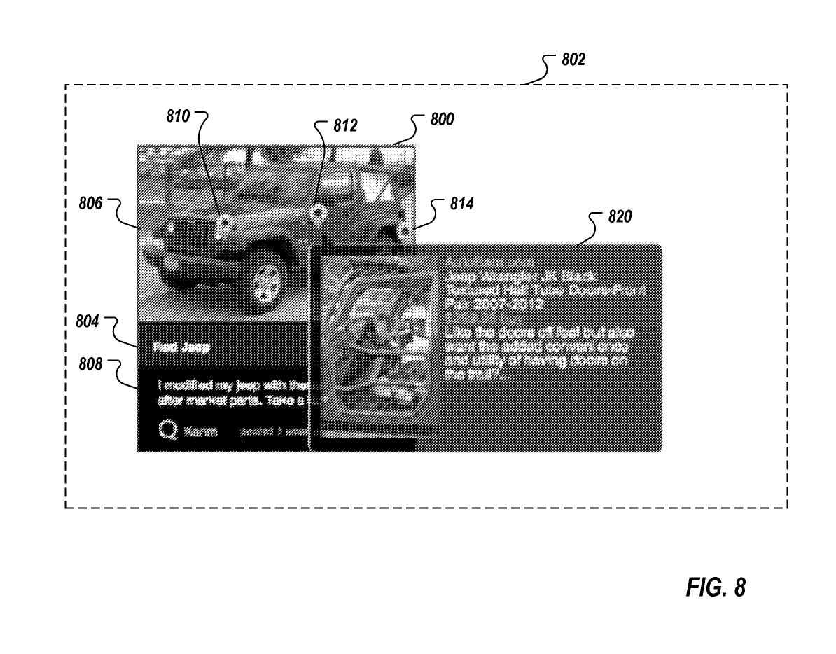

FIG. 8 depicts a partial screenshot including a post 800. For example, the post 800 can be displayed in a third-party service. In the depicted example, the post 800 had been exported to a third-party service and is displayed in a display 802 provided by the third-party service. In some examples, the display 802 can include a web page that is provided by the third-party service.

In the example of FIG. 8, the post 800 includes a post title 804 (“Fixed Jeep”), an image 806, and comments 808. In the depicted example, the image 806 is associated with tags 810, 812, 814. In accordance with implementations of the present disclosure, the user viewing the post 800 can interact with (e.g., click-on, hover-over) one or more of the tags 810, 812, 814. For example, the user can click on the tag 812, and in response, detail regarding the item associated with the tag 812 can be displayed to the user. In some examples, the tags 810, 812, 814 can include user-defined tags, affiliate tags, and/or enterprise tags.

In the depicted example, a detail interface 820 is displayed in response to the user interacting with the tag 812. The detail interface 820 provides detail regarding the item associated with the selected tag, detail regarding a retailer, from which the item can be purchased, and/or a channel for purchasing the item. In the depicted example, the detail interface 820 depicts an image of the item, a model of the item (e.g., Jeep Wrangler JK

Black Textured Half Tube Doors-Front Pair 2007-2012), price of the item, and a description of the item. In the depicted example, the detail interface 820 further indicates a retailer that sells the item (e.g., “AutoBarn.com”), and a channel (e.g., a link “buy”) to initiate purchase of the item. For example, the user can select (e.g., click-on) the channel (“buy”), and in response, the user can navigate to an interface (e.g., a web page) to purchase the item.

Implementations of the subject matter and the operations described in this specification can be realized in digital electronic circuitry, or in computer software, firmware, or hardware, including the structures disclosed in this specification and their structural equivalents, or in combinations of one or more of them. Implementations of the subject matter described in this specification can be realized using one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer can include a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any implementation of the present disclosure or of what may be claimed, but rather as descriptions of features specific to example implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A computer-implemented method executed using one or more processors, the method comprising:
receiving, by the one or more processors, digital content, the digital content being received from a user;
receiving, by the one or more processors, user input, the user input defining a set of tags to be associated with the digital content, the set of tags comprising one or more tags, each tag providing a channel through which users can procure one or more products and/or services;
in response to receiving the user input, associating meta-data with the digital content to provide tagged digital content, the meta-data defining the one or more tags of the set of tags;
distributing, by the one or more processors, the tagged digital content for display of the digital content and the set of tags to one or more users;
determining, by the one or more processors, that a compensation event has occurred based on the tagged digital content; and
facilitating compensation of the user based on the compensation event.

2. The method of claim 1, wherein at least one tag of the set of tags comprises a user-defined tag.

3. The method of claim 1, wherein at least one tag of the set of tags comprises an affiliate tag.

4. The method of claim 3, wherein the affiliate tag is selected by the user from a library of affiliate tags.

5. The method of claim 1, wherein at least one tag of the set of tags comprises an enterprise tag.

6. The method of claim 1, wherein at least one tag of the set of tags comprises a link to a resource, through which users are able to procure the one or more products and/or services.

7. The method of claim 6, wherein the resource comprises a web-site.

8. The method of claim 1, wherein the compensation event comprises a conversion.

9. The method of claim 8, wherein the conversion is initiated through a tag of the set of tags.

10. The method of claim 1, wherein the compensation event comprises an impression, the impression comprising a view of the tagged digital content.

11. The method of claim 1, wherein the compensation event comprises a click-on at least one of the tagged digital content and a tag of the set of tags.

12. A system comprising:
a data store for storing data; and
one or more processors configured to interact with the data store, the one or more processors being further configured to perform operations in accordance with the method of any comprising:
receiving digital content, the digital content being received from a user;
receiving user input, the user input defining a set of tags to be associated with the digital content, the set of tags comprising one or more tags, each tag providing a channel through which users can procure one or more products and/or services;
in response to receiving the user input, associating meta-data with the digital content to provide tagged digital content, the meta-data defining the one or more tags of the set of tags;
distributing the tagged digital content for display of the digital content and the set of tags to one or more users;
determining that a compensation event has occurred based on the tagged digital content; and
facilitating compensation of the user based on the compensation event.

13. A non-transitory computer readable medium storing instructions that, when executed by one or more processors, cause the one or more processors to perform operations comprising:
receiving digital content, the digital content being received from a user;
receiving user input, the user input defining a set of tags to be associated with the digital content, the set of tags comprising one or more tags, each tag providing a channel through which users can procure one or more products and/or services;
in response to receiving the user input, associating meta-data with the digital content to provide tagged digital content, the meta-data defining the one or more tags of the set of tags;
distributing the tagged digital content for display of the digital content and the set of tags to one or more users;
determining that a compensation event has occurred based on the tagged digital content; and
facilitating compensation of the user based on the compensation event.
